(19) United States
(12) Patent Application Publication
(10) Pub. No.: US 2019/0070647 A1
(43) Pub. Date: Mar. 7, 2019

(54) CAPPING OF SOFT TAILINGS DEPOSITS

(71) Applicant: SYNCRUDE CANADA LTD. in trust for the owners of the Syncrude Project as such owners exist now and, Fort McMurray (CA)

(72) Inventors: NAN WANG, Edmonton (CA); TREVOR FINLAYSON, Fort McMurray (CA); GLEN MILLER, Fort McMurray (CA); GEORGE DOGBE, Fort McMurray (CA); WAYNE MIMURA, Fort McMurray (CA); COLLEEN MACNEIL, Fort McMurray (CA); ANA MANDERSON, Edmonton (CA); SHAHRAM YAZDANPANAH, Calgary (CA)

(21) Appl. No.: 16/020,809

(22) Filed: Jun. 27, 2018

Related U.S. Application Data
(60) Provisional application No. 62/526,027, filed on Jun. 28, 2017.

(51) Int. Cl. B09B 1/00; E02D 3/12

(52) U.S. Cl. CPC B09B 1/004; E02D 3/12; E02D 2300/0037; E02D 2300/0006; E02D 2300/0079; E02D 2300/0084

(57) ABSTRACT

A process for reclaiming soft tailings comprising capping a soft tailings deposit with at least one capping material to form a trafficable surface atop the soft tailings is provided, wherein the capping material comprises water, coarse tailings, sand, petroleum coke, clay-shale overburden, glacial (PG)/Glacio-lacustrine (PL) deposits, geosynthetics or combinations thereof.

### FIELD OF THE INVENTION

The present invention relates to a process for reclaiming soft tailings deposits by capping. In particular, soft tailings produced during oil sands bitumen extraction and bitumen upgrading are capped with a variety of materials to provide a surface that is trafficable for future reclamation activities.

### BACKGROUND OF THE INVENTION

Oil sand generally comprises water-wet sand grains held together by a matrix of viscous heavy oil or bitumen. Bitumen is a complex and viscous mixture of large or heavy hydrocarbon molecules which contain a significant amount of sulfur, nitrogen and oxygen. The key characteristic of Alberta oil sand that makes bitumen economically recoverable is that the sand grains are hydrophilic and encapsulated by a water film which is then covered by bitumen. The water film prevents the bitumen from being in direct contact with the sand and, thus, by slurrying mined oil sand with heated water, the bitumen is allowed to be liberated from the sand grains and move to the aqueous phase. A primary separation vessel (PSV) is normally used for bitumen separation from the solids to produce bitumen froth.

The PSV product, or primary bitumen froth, is a mixture of bitumen, water, and solids. The target composition of this froth product is ≥60 wt % in bitumen, ≤30 wt % in water, and ≤10 wt % in solids. To enable downstream upgrading, the PSV froth must first be cleaned in a froth treatment process to reduce the water and solids contents to desirable levels. Currently, two different types of froth treatment processes are commercially employed; naphthenic froth treatment, which uses a naphtha diluent typically obtained from the downstream coking of bitumen, and paraffinic froth treatment, which uses a paraffinic diluent composed of a mixture of hexanes and pentanes. Froth treatment involves the removal of water and solids still present in the deaerated bitumen froth to produce a bitumen product for upgrading.

At each stage of extraction of bitumen from oil sand and bitumen froth treatment, large volumes of tailings composed of varying degrees of sand, fine silts, clays, residual bitumen and water are produced. Many of the tailings streams produced are comprised primarily of “fines”, i.e., mineral fractions with a particle diameter less than 44 microns. A “fine tailings” suspension is typically 85% water and 15% fine particles by mass. Dewatering of fine tailings occurs very slowly. When first discharged in ponds, any high density solids will sink to the bottom and separate from the very low density material, which is generally referred to as thin fine tailings. After a few years when the thin fine tailings have reached a solids content of about 30-35%, they are referred to as “fluid fine tailings” (FFT) or mature fine tailings (MFT), which behave as a fluid-like colloidal material. The fact that fluid fine tailings behave as a fluid and have very slow consolidation rates significantly limits options to reclaim tailings ponds.

It is particularly challenging to dewater or solidify fluid fine tailings (FFT) to the point where these tailings can support standard reclamation equipment and techniques. Recently, the present applicant developed a process for dewatering oil sands tailings, including FFT, by treating tailings with coagulant and flocculant prior to dewatering by centrifugation (see Canadian Patent No. 2,787,607, incorporated hereto by reference). The centrifugation process is particularly useful with, but not limited to, fluid fine tailings (FFT). However, the resultant centrifuge cake, referred to herein as centrifuged FFT or cFFT, may not always possess sufficient shear strength and, thus, bearing capacity to support the earth moving equipment needed for closure and reclamation operations.

Another process developed to address the issue of fluid fine tailings (FFT) is the composite tailings (CT) process, which involves combining gypsum and sand with FFT. CT technology causes the FFT to consolidate faster, however, the CT material produced (referred to herein as composite tailings or CT) is often not strong enough (i.e., possess sufficient shear strength) for immediate reclamation. These treated tailings are also referred to as non-segregating tailings or NST, where cyclone underflow of coarse tailings is used as “sand”.

Fluid fine tailings can also be treated with a flocculant, coagulant, or both, and thickened in a thickener or by in-line treatment. However, the resultant thickened tailings or TT still does not have the shear strength to support standard reclamation equipment and techniques.

Fluid fine tailings can be treated with a flocculant and then deposed in thin layers for further drying (also referred to as “thin lift”). However, the consistency of dried FFT (dFFT) can vary from very soft to firm and, thus, may also not have sufficient shear strength for reclamation.

Other tailings requiring reclamation are referred to as tailings beaches, which are the beached solids found below the FFT layer in a tailings pond, referred to herein as beaches below fluid fine tailings or BB-FFT. BB-FFT is a mixture of sandy FFT that is highly variable with respect to wt. % solids and consistency. These tailings also do not have the shear strength for immediate reclamation.

Froth treatment tailings (FTT) are also comprised of a high concentration of fines. However, the wt. % fines is highly variable and the consistency is also variable. Thus, often FTT does not have sufficient shear strength to support the earth moving equipment needed for closure and reclamation operations.

Thus, it is clear that much of the oil sand tailings produced in an oil sand mining operation, either untreated or treated, lack sufficient shear strength to support standard reclamation equipment and techniques. Hence, there is a need in the industry for an adaptive management strategy for addressing soft tailings due to the unique nature of each soft tailings deposit.

### SUMMARY OF THE INVENTION

In one aspect, the current application is directed to a process for reclaiming soft tailings comprising capping a soft tailings deposit with at least one capping material to form a surface that is trafficable and useful for reclamation. Useful capping materials include water, coarse tailings (sand), petroleum coke, clay-shale overburden, and subsoils, for example, glacial deposits (PG) and Glacio-lacustrine (PL) deposits. Geosynthetics such as geotextiles may also be used as capping materials. As used herein, “geotextiles” are synthetic products used to stabilize terrain. The present invention can be used to reclaim/densify soft tailings deposits in situ. Soft tailings include untreated fluid fine tailings (uFFT), centrifuged fluid fine tailings (cFFT), dried fluid fine tailings (dFFT), composite tailings (CT), tailings beaches, thickened tailings (TT) and froth treatment tailings (FTT). Once the trafficable surface is formed, in one embodiment, a reclamation material such as topsoil, litter/leaf fibric humic (LFH), woody debris and planting can be placed on top of the trafficable surface.

In one embodiment, a sand cap is used. For example, conventional sand raining techniques or a horizontal Tremie pipe can be used to evenly distribute sand, e.g., coarse tailings sand, across the entire surface of the soft tailings deposit to create a sand layer. In one embodiment, a petroleum coke layer is first applied to the soft tailings deposit prior to capping with sand.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 shows passive gamma profiles when capping soft tailings (composite tailings) with sand.

FIG. 2 shows passive gamma profiles when capping soft tailings (composite tailings) with clay-shale overburden.

FIG. 3 shows the undrained shear strengths at various elevations when soft tailings (centrifuged fluid fine tailings) were capped with a first layer of petroleum coke and a second layer of clay-shale overburden.

FIG. 4 shows the undrained shear strengths at various elevations when soft tailings (centrifuged fluid fine tailings) were capped with clay-shale overburden.

FIG. 5 shows passive gamma profiles when capping soft tailings (tailings beaches) were capped with clay-shale overburden.

FIG. 6 shows the total solids content (wt %) near the mudline when soft tailings (fluid fine tailings) were capped with water.

FIG. 7 shows passive gamma profiles when soft tailings (fluid fine tailings) were capped with coke.

FIG. 8 is a summary of slope stability results when first capping soft tailings with coke followed by a sand surcharge load.

### DETAILED DESCRIPTION OF THE PREFERRED EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

The present invention relates generally to a process of capping soft tailings deposits. As used herein, “soft tailings” is defined as tailings that do not possess sufficient shear strength to support the earth moving equipment needed for closure and reclamation operations. Soft tailings include untreated fluid fine tailings (uFFT), densified fluid fine tailings such as centrifuged fluid fine tailings (cFFT) and dried fluid fine tailings (dFFT), composite tailings (CT), tailings beaches, e.g., beaches below FFT, thickened tailings (TT) and froth treatment tailings (FTT). Often, soft tailings have a high fines content, where fines content can be as high as 80 wt % or higher.

Table 1 tabulates common types and typical properties of oil sand tailings. Currently, the present applicant generates and stores untreated FFT (uFFT), centrifuged FFT (cFFT), gypsum-amended Non-Segregating Tailings (NST or CT), beach below FFT (BB-FFT), Froth Treatment Tailings (FTT or Plant 6 tailings) and Tailings Sands (TS) in various tailings storage facilities. Other than the FTT and TS, the rest of the tailings materials are known as soft tailings and do not have sufficient shear strength to support standard reclamation equipment and techniques, which poses a big challenge to sustainable development of oil sands resources.

TABLE 1
Typical Properties of Common Oil Sands Tailings Types

| Tailings Type | Description | Typical Properties |
|---|---|---|
| Untreated FFT | Settled fines | 30-40 wt % solids |
| (uFFT) | segregated from | >80% fines |
| | whole tailings | Fluid consistency |
| Centrifuged FFT | Flocculated/ | 45-60 wt % solids |
| (cFFT) | Coagulated/ | >80% fines |
| | Centrifuged FFT | Fluid to very soft |
| | | consistency |
| Thickened Tailings | Flocculated/ | 35-50 wt % solids |
| (TT) | Coagulated FFT | 50-80% fines |
| | from a thickener or | Fluid to very soft |
| | in-line treatment | consistency |
| Dried FFT | Flocculated FFT | 60-85 wt % solids |
| (dFFT) | deposited in thin | >80% fines |
| | layers for | Very soft to firm |
| | atmospheric drying | consistency |
| Non-Segregating | Mixture of cyclone | 75-84 wt % solids |
| Tailings (NST) | underflow, FFT | ~20% fines |
| | and chemical | Very soft to soft |
| | amendment | consistency |
| Beach below FFT | A mixture of sandy | Highly variable solids % |
| Tailings (BB-FFT) | tailings FFT that | <10%~80% fines |
| Includes sandy/ | forms in conventional | Soft to firm consistency |
| thick FFT | tailings ponds | |
| Froth Treatment | Naphtha or paraffinic | Highly variable solids % |
| Tailings (FTT) | froth tailings | Highly variable fines % |
| | | Fluid to firm |
| | | consistency |
| Tailings Sands | Fine quartz sands | >80 wt % solids |
| | that settle and | 5-10% fines |
| | segregate during | Forms beaches and caps |
| | tailings deposition | |
| Soft Tailings Beaches | Beaches formed above | Higher wt % sand and |
| (STB) | the water layer present | higher wt % solids than |
| | in a tailings pond | BB-FFT |

Due to the low shear strengths of the oil sand soft tailings, various materials have been considered for current capping of soft tailings deposits. The water cap is usually made up of Oil Sands Process-affected Water (OSPW) and/or freshwater. Table 2, below, gives the typical properties for common capping materials available in the oil sands industry. It is understood that other materials can be used, for example, polymeric capping.

TABLE 2
Typical Properties of Common Capping Materials Types

| | | | | | | | | | Standard Proctor | |
|---|---|---|---|---|---|---|---|---|---|---|
| | | Atterberg Limits | | | | | | | Optimum | Maximum |
| | Moisture | Liquid | Plastic | Plasticity | | Particle Size | | | Moisture | Dry |
| | Content | Limit | Limit | Index | Specific | Sands % | Silt % | Clay % | Content | Density |
| Capping Materials | (%) | (%) | (%) | (—) | Gravity | (>75 μm) | (75-2 μm) | (<=2 μm) | (%) | (kg/m³) |
| OSPW/Freshwater | 100 | — | — | — | 1.00 | — | — | — | — | — |
| Coarse Tailings Beach Sands | 17 | — | — | — | 2.65 | 90 | 14 | 1 | — | — |
| Petroleum Coke | 0.2 | Non- | Non- | Non- | 1.59 | 82.2 | 17.9 | 0.0 | 23.0 | 1120 |
| | | plastic | plastic | plastic | | | | | | |
| Clay-shale Overburden (Kc) | 21.8 | 121.3 | 22.4 | 98.9 | 2.73 | 3.0 | 31.0 | 66.0 | 27.6 | 1462 |
| Subsoil (PL and PG) | 19.8 | 40.8 | 15.0 | 25.8 | 2.66 | 23.7 | 35.3 | 41.0 | 18.0 | 1718 |

It is understood that multiple layers of one or more capping materials may be used.

In another aspect of the present invention, adaptive management of soft tailings capping is applied. There may be instances where, in addition to capping, other technologies will be applied, either to the soft deposit, the capping material, or both. For example, geotextiles may be used to first cover the soft tailings deposit prior to capping with a capping material. Other pretreatments of the soft tailings deposit include addition of polymeric flocculants; installing vertical and/or horizontal drains; pre-drying the soft tailings deposit by accelerated dewatering or thin lift deposition; freeze-thaw drying of the soft tailings deposit; co-mixing with a capping material; in situ mixing with Kc overburden; addition of cement, straw, vegetation, gypsum, silica desiccants, a combination of lime and gypsum; to the soft tailings; or any combinations thereof. After pretreatment, the soft tailings deposit is then capped with the capping material of choice.

It is understood that other reclamation or closure topography features can be used after capping, for example, hummocks, swales, slopes, etc. As used herein, “capping” means installing a float cover (i.e., using a capping material) on top of soft tailings, which creates a foundation for subsequent reclamation that includes spreading soil for vegetation.

Polymeric flocculants useful in the present invention are generally anionic, nonionic, cationic or amphoteric polymers, which may be naturally occurring or synthetic, having relatively high molecular weights. Preferably, the polymeric flocculants are characterized by molecular weights ranging between about 1,000 kD to about 50,000 kD. Suitable natural polymeric flocculants may be polysaccharides such as dextran, starch or guar gum. Suitable synthetic polymeric flocculants include, but are not limited to, charged or uncharged polyacrylamides, for example, a high molecular weight polyacrylamide-sodium polyacrylate co-polymer.

Other useful polymeric flocculants can be made by the polymerization of (meth)acryamide, N-vinyl pyrrolidone, N-vinyl formamide, N,N dimethylacrylamide, N-vinyl acetamide, N-vinylpyridine, N-vinylimidazole, isopropyl acrylamide and polyethylene glycol methacrylate, and one or more anionic monomer(s) such as acrylic acid, methacrylic acid, 2-acrylamido-2-methylpropane sulphonic acid (ATBS) and salts thereof, or one or more cationic monomer(s) such as dimethylaminoethyl acrylate (ADAME), dimethylaminoethyl methacrylate (MADAME), dimethydiallylammonium chloride (DADMAC), acrylamido propyltrimethyl ammonium chloride (APTAC) and/or methacrylamido propyltrimethyl ammonium chloride (MAPTAC).

In one embodiment, the polymeric flocculant comprises an aqueous solution of an anionic polyacrylamide. The anionic polyacrylamide preferably has a relatively high molecular weight (about 10,000 kD or higher) and medium charge density (about 20-35% anionicity), for example, a high molecular weight polyacrylamide-sodium polyacrylate co-polymer. The preferred polymeric flocculant may be selected according to the soft tailings composition and process conditions.

The present invention is illustrated in the following examples.

### Example 1

In this example, composite tailings (CT) are placed in a pit and coarse tailings sand, such as primary separation vessel (PSV) tailings, having approximately 90% sand, are hydraulically placed on top of the CT to form caps atop the CT material. The thicknesses of the sand caps can range from approximately 6 meters to 10 meters or greater.

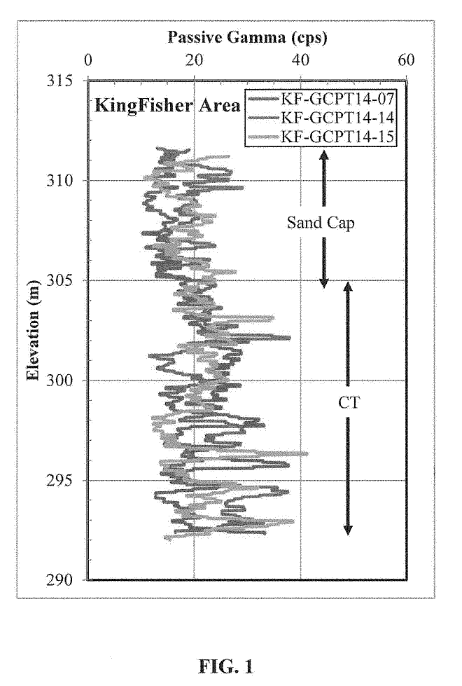

FIG. 1 is a passive gamma profile of a CT deposit capped with 6 meters of sand at three locations, KF-GCPT14-07, KF-GCPT14-14 and KF-GCPT14-15. Passive gamma profiles were collected using a gamma cone penetrometer testing (GCPT). The gamma cone penetrometer is pushed into the deposit and collects natural gamma radiations from clay minerals along the depth. The higher the gamma counts, the higher the clay mineral contents. After calibration, passive gamma profiles can be used to understand the layered structure of the deposits.

### Example 2

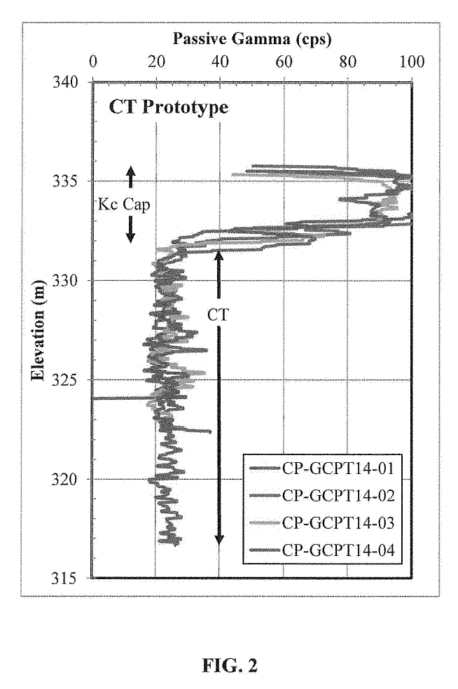

In this example, a CT deposit was capped with clay-shale overburden (Kc overburden). Field sampling was conducted at the CT deposit after the first 3-m-thick lift of Kc overburden had been placed on top of the previously deposited CT. The Kc overburden cap was installed onto a 1.5-m-thick frozen CT surface. FIG. 2 illustrates the passive gamma profiles collected at four locations once the frozen CT surface thawed, which suggests that the 3-m-thick Kc cap stayed on the top of CT.

### Example 3

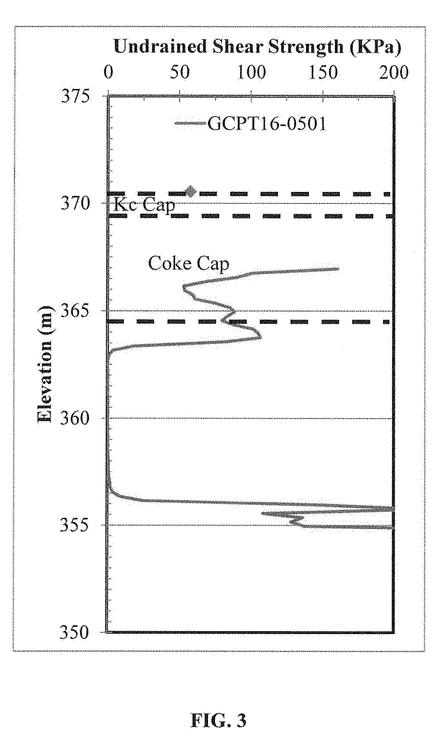

In this example, a trafficability study was done to understand the feasibility of installing a trafficable and reclaimable cap on top of 10-m-deep cFFT (centrifuge cake) test deposits. It was found that the placement of a 5-m-thick petroleum coke cap followed by a 1-m-thick Kc overburden cap on the top of cFFT could satisfy the requirement of supporting unlimited passes of loaded 40-ton articulated dump trucks. FIG. 3 shows an undrained shear strength profile of the cFFT deposit capped with petroleum coke, which suggests that the 5-m-thick coke cap of relatively high shear strengths is sitting on the top of soft cFFT materials. The Kc overburden cap was placed on the top of petroleum coke cap to enhance the coke cap's capability of supporting wheeled traffic.

A trafficability study was also done on a test cFFT deposit where a thinner layer of petroleum coke was used, in the event that petroleum coke supplies were limited. In this instance, a layer of geotextile was used to compensate for the reduction in the thickness of coke cap. It was found that the combination of a 2-m-thick coke cap placed on the top of a layer of geotextile, which is then enhanced by a 1-m-thick Kc overburden cap, would support unlimited passes of loaded 40-ton articulated dump trucks.

In one embodiment, a geotextile was first placed on centrifuged fluid fine tailings (i.e., 10 m thick deposit of centrifuge cake). A 2 m thick layer of petroleum coke was then added, followed by a 1 m thick layer of clay-shale overburden. The ground pressure in this instance is about 44 psi, capable of supporting reclamation equipment.

### Example 4

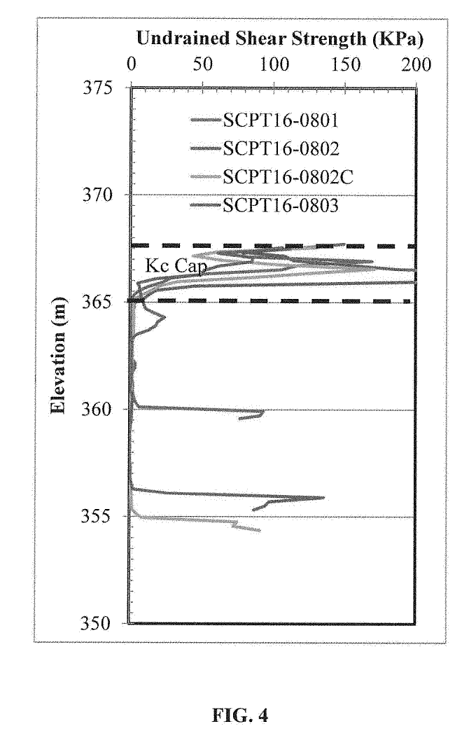

In this example, a 1-m-thick overburden cap made of crushed Kc was placed onto a 10-m-deep cFFT deposit. The thickness of the Kc cap was further increased to 2.5 meters in order to enhance the Kc cap's capability of supporting unlimited passes of loaded 40-ton articulated dump trucks. FIG. 4 shows the undrained shear strength profiles of the cFFT deposit capped with Kc overburden, which suggests that a Kc overburden cap of high shear strengths is sitting right atop soft cFFT materials.

### Example 5

In this example, thickened tailings (TT) were deposited in a 4-m-deep deposit and were allowed to consolidate over time, developing an above-5-kPa undrained shear strength within the deposit and a surface crust of approximately 20-kPa shear strength. A cap consisting of 0.7-m-thick tailings beach sand layer was placed on top of the TT. The release water inside the TT deposit removed prior to the placement of the tailings beach sand cap. A second 0.7-m-thick subsoil layer was then placed on top of the sand cap.

### Example 6

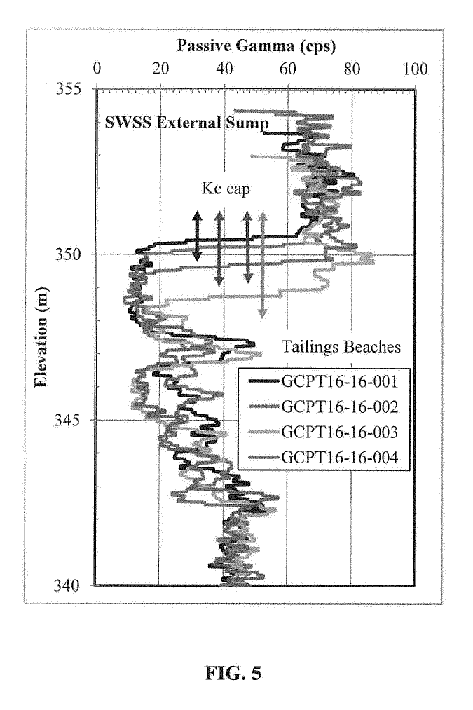

In this example, soft tailings beaches (STB) were capped with a Kc overburden cap of about five meters thick. As shown in FIG. 5, the Kc overburden cap appears to be sitting firmly on the top of a 5-m-thick tailings beach after the Kc placement by the use of Caterpillar D6 dozers. The drained shear strengths of the tailings beaches at elevations between 345 m and 350 m ranged between about 10 and 40 kPa.

### Example 7

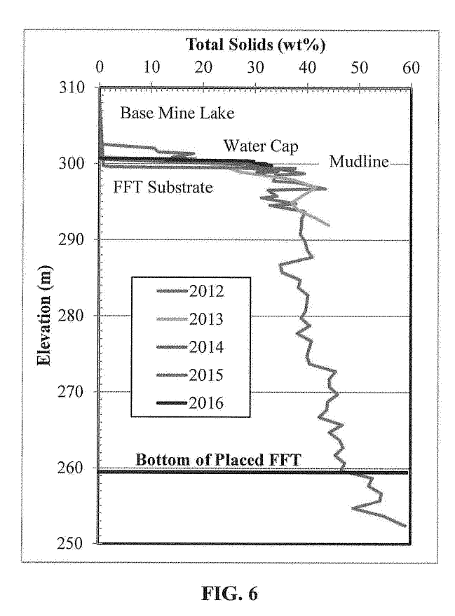

In this example, the soft tailings are untreated fluid fine tailings (uFFT) present in a large pit. Water, such as oil sands process-affected water, fresh water, or a combination of both, is used to cap the soft tailings. FIG. 6 shows the solids content in the vicinity of the interface between the water cap and the top of the untreated FFT, which is commonly referred to as the mud line, in the years 2012-2016. Also shown in FIG. 6 is the solids contents of the untreated FFT prior to capping. Since water capping in 2012, the concentrations of Total Suspended Solids (TSS) in the water cap were generally less than 20 mg/L, which suggests that the tailings fines in the untreated FFT substrate in general did not re-suspend into the water cap. Furthermore, a distinct interface between the untreated FFT and water cap remained in place over time, supporting the concept of capping soft tailings with water in a mined out open pit.

### Example 8

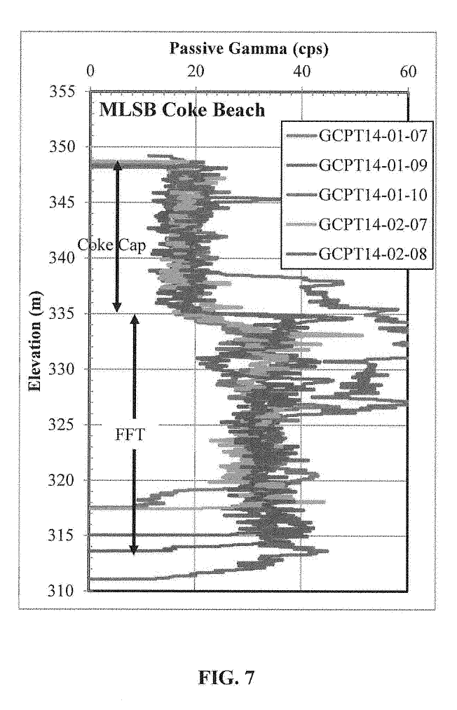

In this example, the soft tailings are untreated fluid fine tailings (uFFT) present in a large pit. A petroleum coke cap was used. As shown in the passive gamma profiles in FIG. 7, a 13 m thick coke cap was formed and the coke cap remained stable over time. FIG. 7 illustrates passive gamma profiles for coke layers atop uFFT layer. Other than GCPT14-01-10, a layer of coke was sitting on uFFT at elevation of 335 m. At GCPT14-01-10, the elevation was 338 m.

### Example 9

In this example, various soft tailings having a range of strengths (Pa) were capped by raining petroleum coke over the soft tailings to form a coke cap to see if the coke-capped soft tailings would then be able to support a sand surcharge load, i.e., a sand cap, having a thickness of 2 m. Without being bound to theory, it is believed that because coke is less dense than sand, it is less likely to overturn the soft tailings or sink in as sand tends to do with certain soft tailings. Further, it is believed that petroleum coke may have an affinity for any residual bitumen which may be present in the soft tailings may be useful in treating the residual water as well. Petroleum coke is produced as a waste product in large amounts during upgrading of bitumen. Thus, use of coke as a capping material may have the additional benefit of disposing of another waste material in addition to tailings.

The following scenarios were confirmed:
150 m long and −30 m thick soft tailings deposit with a sand surcharge
   Flat
   1% slope
   2% slope
600 m long and −30 m thick soft tailings deposit with a sand surcharge
   1% slope
   2% slope.
      The parameters that were varied were the coke cap thickness (0 m to 3 m) and the type (strength) of the soft tailings.

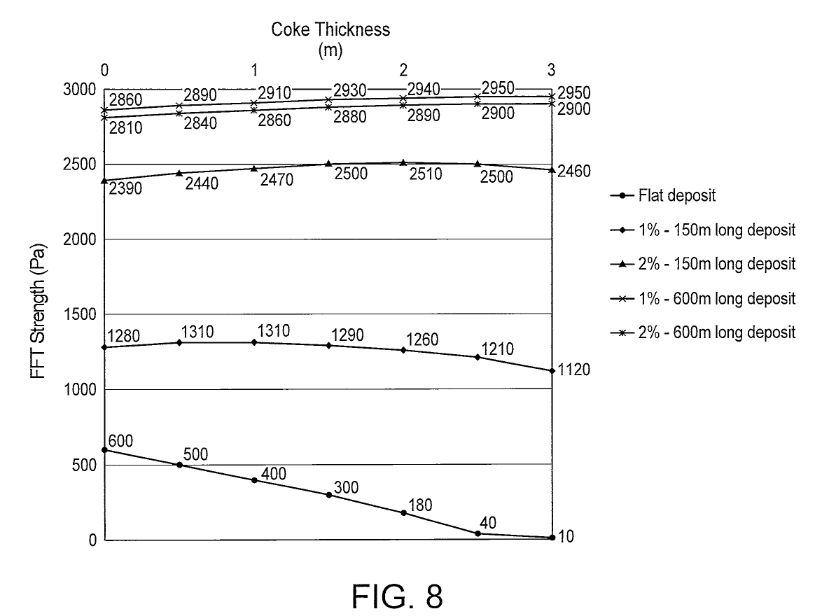

The relationships between soft tailings strength, coke thickness, sand loading, and deposit geometry is shown in FIG. 8. It was discovered that the required soft tailings strength depended on the slope of the deposit. Stronger soft tailings are required for steeper deposit slopes. Further, when dealing with sloped deposits, it was found that the length of the deposit was also a factor. In other words, with sloped deposits, the steeper the slope, the greater the FFT strength required and the longer the deposit, the greater the FFT strength required. However, with larger sloped deposits, the soft tailings strength required to support a 1% or 2% slope appears to be adequately high to support sand alone. The results imply that, after a certain point based on established cap, raining with coke will not be necessary for capping material placement for the deposit to remain stable.

Interestingly, it was discovered that when the soft tailings are untreated fluid fine tailings (uFFT), which have a very low shear strength ranging from about 10 Pa to about 40 Pa, the slope of the deposit was the most important factor in determining appropriate capping materials. It was discovered that a 2.5 to 3 m deep petroleum coke layer could be placed on top of uFFT, provided it was present in a flat deposit, which would be sufficient to support a 2 m sand cap. However, if the deposit had a slope of about 1% or greater, the uFFT would first have to be treated, either by the addition of solids or by the addition of chemicals, such as coagulants and/or flocculants, to increase its shear strength before it could support a 2.5 to 3 meter coke cap.

For example, when the soft tailings are high solids (>60%) tailings such as cFFT, which have a shear strength of around 1200 Pa, and the slope is 1% in a 150 m long deposit, a coke cap depth of 0 m to 3 m would be sufficient to support a 2 m sand cap. However, if the deposit has an even greater slope, i.e., 2%, the shear strength of the soft tailings necessary to support a coke cap followed by a sand cap would have to be in the order of about 2500 Pa, e.g., cFFT that have been drying in a deposit for at least a year.

Thus, when uFFT is used, a coke slurry could be prepared which has a slightly smaller density than the uFFT and can be evenly distributed across the large pit surface by the use of raining technique or horizontal Tremie pipes to generate a coke layer on top of the uFFT. The coke layer may act as a permeable buffer. Then, coarse tailings sand is evenly distributed over top the coke layer by using raining technique or horizontal Tremie pipes to create a sand layer on the top of the coke buffer.

Without being bound to theory, the sand layer exerts surcharge loads onto the uFFT below to promote the dewatering of the uFFT while the coke buffer helps maintain the integrity of the sand cap, allowing consolidation release water to pass through until the soft tailings (uFFT) gains sufficient strength to be characterized as non-fluid or soil. The sand/coke cap may also prevent uFFT from re-suspending into water column.

### Example 10

In this example, a geotextile was first placed on top of a 10-m-deep cFFT (centrifuge cake) deposit. A 2-m-deep coke layer was then applied on top of the geotextile followed by a 1-m-deep layer of Kc overburden, which could satisfy the requirement of supporting unlimited passes of loaded 40-ton articulated dump trucks.

### Example 11

As previously mentioned, placement of capping materials can be done using raining technique or horizontal Tremie pipes. Another useful method for capping material placement, in particular, sand, is referred to herein as “cell pouring”. This technique is particularly useful for specific sand placement applications where the sand component of the tailings is captured in deposit cells while allowing fines to decant off the deposit cells. Examples of where this technique is used include dam upstream filtering, deposit capping and building hummocks. The technique has two embodiments; closed cell construction and open cell construction.

Closed cell construction involves creating a continuous berm nominally 6 feet high by pushing up sand with cell dozers. At the far end of the cell in the toe berm is a decant structure that allows fluid and fines to overflow while trapping the sand within the berms. The elevation of the deposit increases until the sand reaches the berm elevation at which point a new empty cell is created adjacent to the full cell. This process continues until the design objectives are met.

Open cell contraction involves creating a non-continuous berm (usually three sided) nominally 6 feet high by pushing up sand with cell dozers. Generally, there is no toe berm. Spigots or other means to reduce the discharge energy of the tailings slurry are employed to provide a quiescent environment where the sand will settle and the segregated fines will decant off the deposit. This technique is generally used where trafficability of the sub straight prevents toe berm construction.

Open cell construction can also be used for soft deposit capping. The newly poured cells provide a trafficability platform to work from for discharging adjacent open cells. Once a continuous layer of sand of appropriate thickness has been placed using open cell construction methods the entire soft deposit is trafficable for future reclamation activities.

From the foregoing description, one skilled in the art can easily ascertain the essential characteristics of this invention, and without departing from the spirit and scope thereof, can make various changes and modifications of the invention to adapt it to various usages and conditions. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

We claim:

1. A process for reclaiming soft tailings comprising capping a soft tailings deposit with at least one capping material to form a trafficable surface atop the soft tailings which is useful for reclamation.

2. The process as claimed in claim 1, wherein the capping material comprises water, coarse tailings, sand, petroleum coke, clay-shale overburden, PG/PL subsoils, geosynthetics, or combinations thereof.

3. The process as claimed in claim 1, wherein the soft tailings comprises untreated fluid fine tailings (uFFT), centrifuged fluid fine tailings (cFFT), dried fluid fine tailings (dFFT), composite tailings (CT), tailings beaches, thickened tailings (TT) and froth treatment tailings (FTT).

4. The process as claimed in claim 1, further comprising first covering the soft tailings deposit with a geotextile prior to capping with the at least one capping material.

5. The process as claimed in claim 1, further comprising pretreating the soft tailings deposit by addition of polymeric flocculants; installation of vertical and/or horizontal drains; pre-drying the soft tailings deposit by accelerated dewatering or thin lift deposition; freeze-thaw drying of the soft tailings deposit; co-mixing with the reclamation material; in situ mixing with Kc overburden; addition of cement, straw, vegetation, gypsum, silica desiccants, or a combination of lime and gypsum; or any combinations thereof prior to capping with the capping material.

6. The process as claimed in claim 1, wherein the soft tailings are composite tailings and the at least one capping material is sand.

7. The process as claimed in claim 1, wherein the soft tailings are composite tailings and the at least one capping material is clay-shale overburden.

8. The process as claimed in claim 1, wherein the soft tailings are centrifuged fluid fine tailings and the at least one capping material comprises a first layer of petroleum coke and a second layer of clay-shale overburden.

9. The process as claimed in claim 1, wherein the soft tailings are centrifuged fluid fine tailings and the at least one capping material is clay-shale overburden.

10. The process as claimed in claim 1, wherein the soft tailings are thickened tailings and the at least one capping material is tailings beach sand.

11. The process as claimed in claim 1, wherein the soft tailings are soft tailings beaches and the at least one capping material is clay-shale overburden.

12. The process as claimed in claim 1, wherein the soft tailings are untreated fluid fine tailings and the at least one capping material is water.

13. The process as claimed in claim 1, wherein the soft tailings are untreated fluid fine tailings and the at least one capping material is petroleum coke.

14. The process as claimed in claim 1, wherein the soft tailings are untreated fluid fine tailings and the at least one capping material comprises a first layer of petroleum coke and a second layer of sand.

15. The process as claimed in claim 1, further comprising adding a reclamation material on top of the trafficable surface.

16. The process as claimed in claim 1, wherein the reclamation material comprises earth materials including topsoil, woody debris, litter/leaf fibric humic and planting.

17. The process in claim 1, wherein the mass of the capping material provides a surcharge to enhance the consolidation of the soft tailings.

18. The process as claimed in claim 1, wherein the soft tailings are centrifuged fluid fine tailings and the at least one capping material comprises a first geotextile layer, a second coke layer and a third clay-shale overburden layer.
